(19) United States
(12) Patent Application Publication
(10) Pub. No.: US 2007/0210881 A1
(43) Pub. Date: Sep. 13, 2007

(54) BAND-PASS FILTER

(75) Inventor: YEN-YI SHIH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,860

(22) Filed: Nov. 17, 2006

(30) Foreign Application Priority Data
Mar. 8, 2006 (CN) 200610034229.2

(51) Int. Cl. H01P 1/203

(52) U.S. Cl. 333/204

(57) ABSTRACT

A band-pass filter (10) includes a first resonator (140), a second resonator (160), a third resonator (180), an input part (100), and an output part (120). The input part is for receiving electromagnetic signals. The first resonator is electronically connected to the input part. The second resonator is parallel to the first resonator. The output part electronically connected to the second resonator, for transmitting the electromagnetic signals from the second resonator. The third resonator is disposed between the first resonator and the second resonator, and parallel to and offset from the first resonator and the second resonator. Each of the first resonator, the second resonator, and the third resonator has an asymmetrical shape. This structure of the band-pass filter not only has a smaller profile, but also provides a wide frequency range.

### BACKGROUND OF THE INVENTION

1. Field of the Invention

The present invention generally relates to communication filters, and more particularly to a band-pass filter.

2. Description of related art

Conventionally, when a wireless network product is working, harmonic components of high frequencies are generated due to the nonlinear properties of active components of the wireless network product, thereby causing electromagnetic interference (EMI). In order to solve the above-mentioned problem, manufacturers of such wireless network products often use a filter to suppress noise generated by the harmonic components.

To reduce manufacturing costs, planar elements, such as microstrips, are widely used as filters. Reducing profiles of the microstrips and increase frequency ranges thereof are important considerations for further developing the filters.

Therefore, a heretofore unaddressed need exists in the industry to overcome the aforementioned deficiencies and inadequacies.

### SUMMARY OF THE INVENTION

In one aspect of the embodiment, a band-pass filter includes a first resonator, a second resonator, a third resonator, an input part, and an output part. The input part is for receiving electromagnetic signals. The first resonator is electronically connected to the input part. The second resonator is parallel to the first resonator. The output part electronically connected to the second resonator, for transmitting the electromagnetic signals from the second resonator. The third resonator is disposed between and parallel to the first resonator and the second resonator, and offset from the first resonator and the second resonator. Each of the first resonator, the second resonator, and the third resonator has an asymmetrical shape.

Other advantages and novel features will become more apparent from the following detailed description when taken in conjunction with the accompanying drawings, in which:

### BRIEF DESCRIPTION OF THE DRAWINGS

FIG. 1 is a schematic diagram of a band-pass filter of an exemplary embodiment of the present invention; and

FIG. 2 is a diagram of simulated test results showing a relationship between transmission and reflection coefficient and frequency of electromagnetic signals traveling through the band-pass filter.

### DETAILED DESCRIPTION OF THE INVENTION

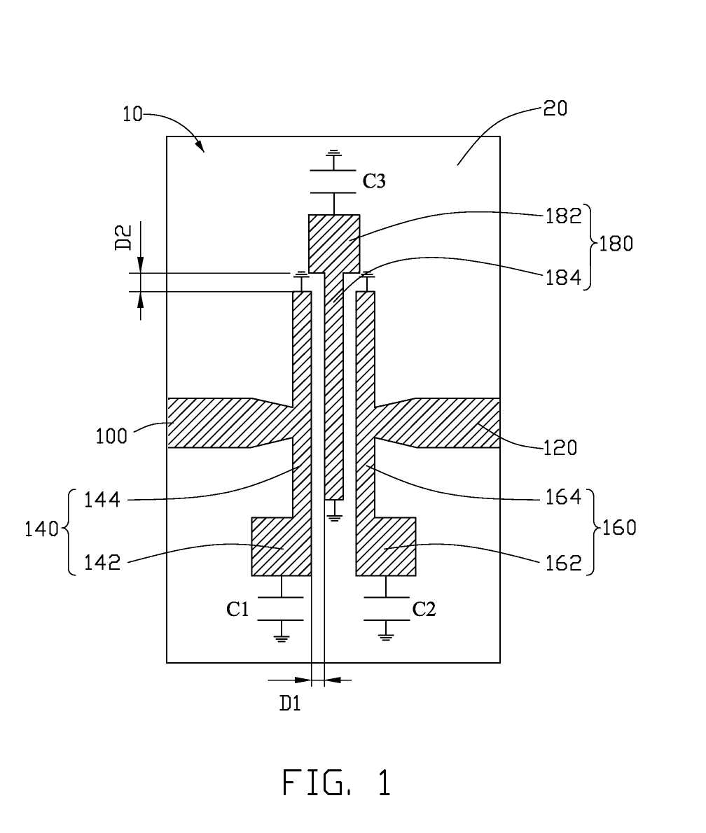

FIG. 1 is a schematic diagram of a band-pass filter 10 according to an exemplary embodiment of the present invention.

The band-pass filter 10 is printed on a substrate 20, and is used for filtering harmonic electromagnetic signals. The band-pass filter 10 includes an input part 100, an output part 120, a first resonator 140, a second resonator 160, and a third resonator 180.

The input part 100 receives electromagnetic signals, and the output part 120 transmits the electromagnetic signals. The input part 100 and the output part 120 are configured in a line. In this embodiment, the input part 100 and the output part 120 are designed as 50 ohm, which is the system impedance for current communication products.

The first resonator 140 is electronically connected to the input part 100. The second resonator 160 is parallel to the first resonator 140, and is electronically connected to the output part 120. The third resonator 180 is disposed between the first resonator 140 and the second resonator 160, and is parallel to and offset from the first resonator 140 and the second resonator 160.

The first resonator 140 has an asymmetrical shape, and includes a first coupling part 142 and a first coupling line 144 electronically connected to the first coupling part 142. The first coupling part 142 is substantially rectangular-shaped to have a larger width than the first coupling line 144, and the first coupling part 142 is electronically connected to a capacitor C1. In the exemplary embodiment, capacitance of the capacitor C1 is 0.5 pF. The first coupling line 144 has two ends: one is grounded, and the other is electronically connected to the first coupling part 142. The input part 100 is electronically connected to the first coupling line 144, and substantially connected to a middle of the first resonator 140, for inputting the electromagnetic signals to the first resonator 140.

The second resonator 160 has an asymmetrical shape, and includes a second coupling part 162 and a second coupling line 164 electronically connected to the second coupling part 162. The second coupling part 162 is substantially rectangular shaped to have a larger width than the second coupling line 164, and is electronically connected to a capacitor C2. In the exemplary embodiment, capacitance of the capacitor C2 is also 0.5 pF. The second coupling line 164 has two ends: one is grounded, and the other is electronically connected to the second coupling part 162. The output part 120 is electronically connected to the second coupling line 164, and substantially connected to a middle of the second resonator 160, for outputting the electromagnetic signals received from the second resonator 160.

The third resonator 180 has an asymmetrical shape, and includes a third coupling part 182 and a third coupling line 184 electronically connected to the third coupling part 182. The third coupling part 182 is substantially rectangular shaped to have a larger width than the third coupling line 184, and is electronically connected to a capacitor C3. In the exemplary embodiment, capacitance of the capacitor C3 is 0.5 pF. The third coupling line 184 has two ends: one is grounded, and the other is electronically connected to the third coupling part 182. In the exemplary embodiment, the third coupling line 184 is electronically connected to a middle of the third coupling part 182.

In the exemplary embodiment, shapes and sizes of the first coupling part 142, the second coupling part 162, and the third coupling part 182 are substantially same. Lengths and widths of the first coupling line 144, the second coupling line 164, and the third coupling line 184 are substantially same.

In the exemplary embodiment, the first resonator 140 and the second resonator 160 are symmetrically disposed on two sides of the third resonator 180, and have a same shape. The third coupling line 184 is parallel to and offset from the first coupling line 144 and the second coupling line 164. The first coupling part 142 and the second coupling part 162 are located at one side of the band-pass filter 10. The third coupling part 182 is located at an opposite side of the band-pass filter 10.

The electromagnetic signals from the input part 100 are transmitted into the first resonator 140, and then transmitted to the third resonator 180 and the second resonator 160, and eventually are output via the output part 120.

In the exemplary embodiment, lengths and widths of the first coupling part 142, the second coupling part 162, and the third coupling part 182 are all about 0.64 millimeter (mm). Lengths of the first coupling line 144, the second coupling line 164 and the third coupling line 184 are all about 2.45 mm, and widths of the first coupling line 144, the second coupling line 164 and the third coupling line 184 are all about 0.2 mm. Distances D1 between the first coupling line 144, the second coupling line 164, and the third coupling line 184 are both 0.15 mm. A perpendicular distance D2 between the first ground end (or the second ground end) and the third coupling part 182 is 0.2 mm.

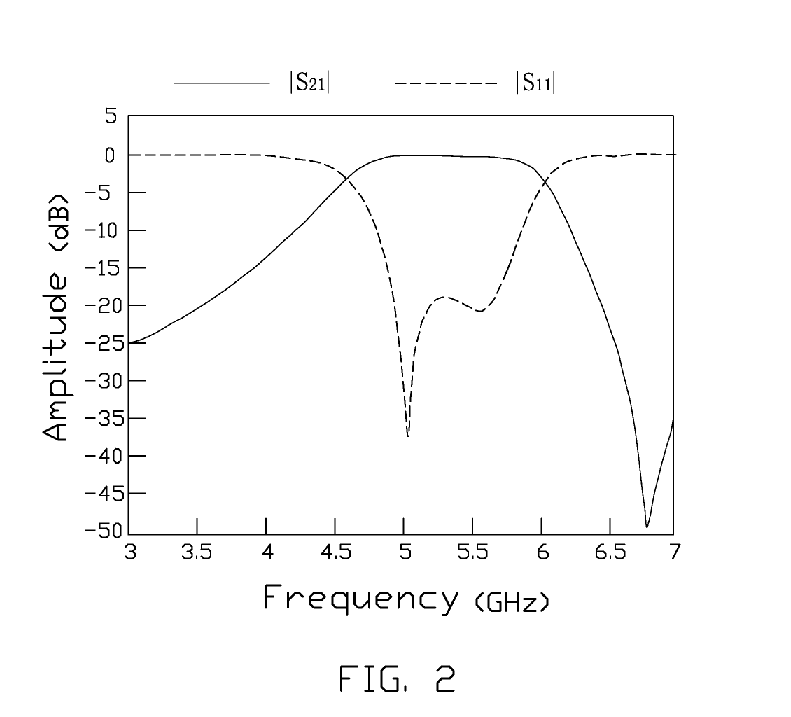

FIG. 2 is a diagram of simulated test results showing a relationship between transmission and reflection coefficient and frequency of electromagnetic signals traveling through the band-pass filter 10. The horizontal axis represents the frequency in gigahertz (GHz) of electromagnetic signals traveling through the band-pass filter 10, and the vertical axis represents the transmission coefficient and the reflection coefficient in decibels (dB) of the band-pass filter 10. The curve |S2| represents the transmission coefficient indicating a relationship between input power and output power of the electromagnetic signals traveling through the band-pass filter 10, and the transmission coefficient is calculated by the following equation:

Transmission coefficient (dB)=10*log[|S21|]=10*Log [(Output Power)/(Input Power)], when port 2 is terminated in matched loads

When electromagnetic signals travel through the band-pass filter 10, a part of input power of the electromagnetic signals is returned to a source of the electromagnetic signals. The part of the input power returned to the source of the electromagnetic signals is called return power. The curve |S11| represents the reflection coefficient (dB) indicating a relationship between the input power and the return power of the electromagnetic signals traveling through the band-pass filter 10, and the reflection coefficient (dB) is represented by the following equation:

Reflection coefficient (dB)=10*log[|S11|]=10*Log [(Return Power)/(Input Power)], when port 2 is terminated in matched loads

For a filter, when the output power of the electromagnetic signals in a pass band frequency range is close to the input power of the electromagnetic signals, and the return power of the electromagnetic signals is small, it means that a distortion of the electromagnetic signals is small, and the performance of the band-pass filter is good. That is, the smaller the absolute value of the transmission coefficient of the electromagnetic signals is, and the bigger the absolute value of the reflection coefficient of the electromagnetic signals is, the better the performance of the filter is.

As indicated by the curve |S21| of FIG. 2, the absolute value of the transmission coefficient of the electromagnetic signals in the pass band frequency range is close to 0. For the curve |S11|, the absolute value of the reflection coefficient of the electromagnetic signals in the pass band frequency range is greater than 10, and the absolute value of the reflection coefficient of the electromagnetic signals beyond the pass band frequency range is less than 10. Therefore, the band-pass filter 10 has good performance. Moreover, in the exemplary embodiment, the band-pass filter 10 has a large pass band frequency range of 4900 MHz-5820 MHz. The pass band frequency range of the band-pass filter 10 covers both a Japanese standard frequency range of 4900 MHz-5320 MHz and an American standard frequency range of 5150 MHz-5350 MHz and 5745 MHz-5820 MHz, which meets operating standards set forth in IEEE 802.11a.

In the exemplary embodiment, each resonator 140, 160, 180 is an asymmetrical stepped impedance resonator formed by one coupling line 144, 164, 184 electronically connected to one coupling part 142, 162, 182, and the three asymmetrical stepped impedance resonators 140, 160, 180 are configured in an offset manner to form the band-pass filter 10. This structure of the band-pass filter 10 not only has a good filtering function and a smaller profile, but also provides a wider frequency range.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A band-pass filter, comprising:
an input part for receiving electromagnetic signals;
a first resonator electronically connected to the input part, and the first resonator having an asymmetrical shape;
a second resonator parallel to the first resonator, and the second resonator having an asymmetrical shape;
an output part electronically connected to the second resonator, for transmitting the electromagnetic signals from the second resonator; and
a third resonator disposed between the first resonator and the second resonator, parallel to and offset from the first resonator and the second resonator, and the third resonator having an asymmetrical shape.

2. The band-pass filter of claim 1, wherein the first resonator and the second resonator are symmetrically disposed on two sides of the third resonator.

3. The band-pass filter of claim 2, wherein the first resonator and the second resonator have a same shape.

4. The band-pass filter of claim 1, wherein the input part and the output part are configured in a line.

5. The band-pass filter of claim 4, wherein the input part is substantially electronically connected to a middle of the first resonator, and the output part is substantially electronically connected to a middle of the second resonator.

6. The band-pass filter of claim 4, wherein the input part and the output part are designed as 50 ohm.

7. The band-pass filter of claim 1, wherein the first resonator, the second resonator, and the third resonator are all asymmetrical stepped impedance resonators.

8. The band-pass filter of claim 1, wherein each of the first resonator, the second resonator, and the third resonator has two ends, wherein one end is grounded, and the other end is electronically connected to a capacitor.

9. The band-pass filter of claim 8, wherein the end of the first resonator connected to the capacitor and the end of the second resonator connected to the capacitor are located at one side of the band-pass filter, and the end of the third resonator connected to the capacitor is located at another side of the band-pass filter.

10. The band-pass filter of claim 1, wherein the first resonator comprises a first coupling part and a first coupling line electronically connected to the first coupling part.

11. The band-pass filter of claim 10, wherein the first coupling part is electronically connected to a first capacitor, and the first coupling line is grounded.

12. The band-pass filter of claim 10, wherein the second resonator comprises a second coupling part and a second coupling line electronically connected to the second coupling part.

13. The band-pass filter of claim 12, wherein the second coupling part is electronically connected to a second capacitor, and the second coupling line is grounded.

14. The band-pass filter of claim 12, wherein the input part is electronically connected to the first coupling line, and the output part is electronically connected to the second coupling line.

15. The band-pass filter of claim 12, wherein the third resonator comprises a third coupling part and a third coupling line electronically connected to the third coupling part.

16. The band-pass filter of claim 15, wherein the third coupling part is electronically connected to a third capacitor, and the third coupling line is grounded.

17. The band-pass filter of claim 15, wherein shapes and sizes of the first coupling part, the second coupling part, and the third coupling part are substantially same, and lengths and widths of the first coupling line, the second coupling line, and the third coupling line are substantially same.

18. The band-pass filter of claim 15, wherein the first coupling part and the second coupling part are located at one side of the band-pass filter, and the third coupling part is located at another side of the band-pass filter.

19. A filter comprising:
an input part for receiving electromagnetic signals in said filter;
an output part spaced from said input part for transmitting said electromagnetic signals out of said filter;
a first resonator electrically connectable with said input part and spaced from said output part for accepting said electromagnetic signals from said input part;
a second resonator electrically connectable with said output part and spaced from said first resonator to transmit said electromagnetic signals to said output part; and
a third resonator disposed between said first and second resonators and spaced from said first and second resonators for transmitting said electromagnetic signals therebetween; wherein
at least one of said first, second and third resonators comprises a widened coupling part at only one end thereof.

20. A filter comprising:
an input part for receiving electromagnetic signals in said filter;
an output part spaced from said input part for transmitting said electromagnetic signals out of said filter;
a first resonator electrically connectable with said input part and spaced from said output part for accepting said electromagnetic signals from said input part, said first resonator comprising a first widened coupling part at one end thereof;
a second resonator electrically connectable with said output part and spaced from said first resonator to transmit said electromagnetic signals to said output part, said second resonator comprising a second widened coupling part at one end thereof; and
a third resonator disposed between said first and second resonators and spaced from said first and second resonators for transmitting said electromagnetic signals therebetween, said third resonator comprising a third widened coupling part at one end thereof; wherein
a widened coupling part of a selective one of said first, second and third resonators locates at a side of said filter opposite to another widened coupling part of another of said first, second and third resonators neighboring said selective one of said first, second and third resonators.
